(19) United States
(12) Patent Application Publication
(10) Pub. No.: US 2010/0201974 A1
(43) Pub. Date: Aug. 12, 2010

(54) SURFACE MEASUREMENT APPARATUS AND SURFACE MEASUREMENT METHOD

(75) Inventors: Tak Gyum KIM, Yongin (KR); Bae Kyun Kim, Seongnam (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/613,177

(22) Filed: Nov. 5, 2009

(30) Foreign Application Priority Data
Feb. 6, 2009 (KR) 10-2009-0009746

(51) Int. Cl. G01N 21/94

(52) U.S. Cl. 356/237.2; 356/237.4

(57) ABSTRACT

There are provided a surface measurement apparatus and a surface measurement method. A surface measurement apparatus according to an aspect of the invention may include: a stage receiving a target object and causing linear and rotational movements of the target object; a light source irradiating a beam onto the target object and rotating relative to the stage; and a reflected-beam detection unit detecting a beam reflected from the target object.

According to an aspect of the invention, a surface measurement apparatus and a surface measurement method can maximize detection performance by detecting foreign bodies present on a surface regardless of optical axes of the beams used for detection.

### CROSS-REFERENCE TO RELATED APPLICATIONS

This application claims the priority of Korean Patent Application No. 10-2009-0009746 filed on Feb. 6, 2009, in the Korean Intellectual Property Office, the disclosure of which is incorporated herein by reference.

### BACKGROUND OF THE INVENTION

1. Field of the Invention

The present invention relates to a surface measurement apparatus and a surface measurement method, and more particularly, to a surface measurement apparatus and a surface measurement method that can maximize detection performance by detecting foreign bodies present on a surface regardless of optical axes of the beams used for detection.

2. Description of the Related Art

In general, semiconductor integrated circuits are fabricated in such a way that circuits are formed on a wafer using a photolithography process. Here, a plurality of identical integrated circuits are arranged on a wafer, and the wafer is then diced into individual integrated circuit chips. If foreign bodies are present on the wafer surface in these semiconductor integrated circuits, the circuit patterns to be formed on the foreign bodies are susceptible to defects. Thus, the corresponding integrated circuits may become unusable. As a result, the number of integrated circuits that can be obtained from a single wafer is reduced, and thus yield is reduced. In addition to semiconductor integrated circuits, examples of state-of-the-art materials that are adversely affected by the presence of micrometer sized foreign objects or defects may include glass for displays and circuit board materials. Therefore, there has been a need for equipment for measuring and inspecting these foreign bodies or defects.

In general, according to a method being used in order to detect foreign bodies on the wafer surface, laser beams are converged on the wafer surface, light being scattered from a converging point is received, and foreign bodies are detected using a signal associated with the received light.

FIG. 1 is a perspective view illustrating a schematic view illustrating a surface measurement apparatus according to the related art.

Referring to FIG. 1, a surface measurement apparatus 10 according to the related art includes a light source for emitting laser beams L, a target object 11 such as a wafer, and first and second beam detection units 12 and 13. Here, the first beam detection unit 12 detects beams Ls scattered from the wafer 11. That is, light, scattered from a light converging point on the wafer 11, is collected in the first beam detection unit 12 serving as a photoelectric converter, through a lens. The first beam detection unit 12, having received the scattered light, outputs a pulsed signal corresponding to the intensity of beams L scattered by foreign bodies. Thus, the sizes of the foreign bodies can be determined according to the magnitude of the output signal. The second beam detection unit 13 detects beams Lr reflected from the wafer 11. As the surface measurement apparatus 10 detects signals according to both scattered and reflected beams, the surface measurement apparatus 100 can determine the presence of foreign bodies on the wafer 11, measure the sizes of the foreign bodies, and further measure the angles of the reflected beams to obtain a three-dimensional shape.

### SUMMARY OF THE INVENTION

An aspect of the present invention provides a surface measurement apparatus and a surface measurement method that can maximize detection performance by detecting foreign bodies present on a surface regardless of optical axes of the beams used for detection.

According to an aspect of the present invention, there is provided a surface measurement apparatus including: a stage receiving a target object and causing linear and rotational movements of the target object; a light source irradiating a beam onto the target object and rotating relative to the stage; and a reflected-beam detection unit detecting a beam reflected from the target object.

The light source may perform a rotational movement relative to the stage at an angle between 0 degrees to 90 degrees.

The light source may perform a rotational movement around the stage that is fixed.

The light source may irradiate a beam onto a predetermined region while the light source is rotating.

The light source and the reflected-beam detection unit may be formed into a single body.

The stage may cause a linear one-way movement and a rotational movement of the target object at the same time during measurement.

The reflected-beam detection unit may include first and second reflected-beam detection units, and may further include a beam splitter splitting a beam moving toward the reflected-beam detection unit and supplying the split beams to the first and second reflected-beam detection units.

The first reflected-beam detection unit may be a position signal detection unit, and the second reflected-beam detection unit may be a reflected-light amount measurement unit.

The surface measurement apparatus may further include a scattered-beam detection unit located above the target object and detecting a beam scattered from the target object.

The surface measurement apparatus may further include a focusing lens focusing the beam scattered from the target object and supplying the focused beam to the scattered-beam detection unit.

According to another aspect of the present invention, there is provided a surface measurement method including: disposing a target object on a stage; performing linear and rotational movements of the target object; emitting a beam from a light source and irradiating the beam onto the target object; and disposing a reflected-beam detection unit and detecting beams reflected from the target object, wherein the irradiating of the beams onto the target object is performed while the position of the light source is shifted relative to the stage.

The irradiating of the beams onto the target object may be performed while the light source performs a rotational movement relative to the stage.

The rotational movement may be performed at an angle between 0 and 90 degrees.

The irradiating of the beams onto the target object may be performed at positions of 0 degrees, 45 degrees and 90 degrees, when the original position of the light source is at an angle of 0 degrees with respect to the stage.

The irradiating of the beams onto the target object may be performed at positions of 0 degrees, 30 degrees, 60 degrees and 90 degrees, when the original position of the light source is at an angle of 0 degrees with respect to the stage.

The light source and the reflected-beam detection unit may be formed into a single body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a schematic view illustrating a surface measurement apparatus according to the related art;

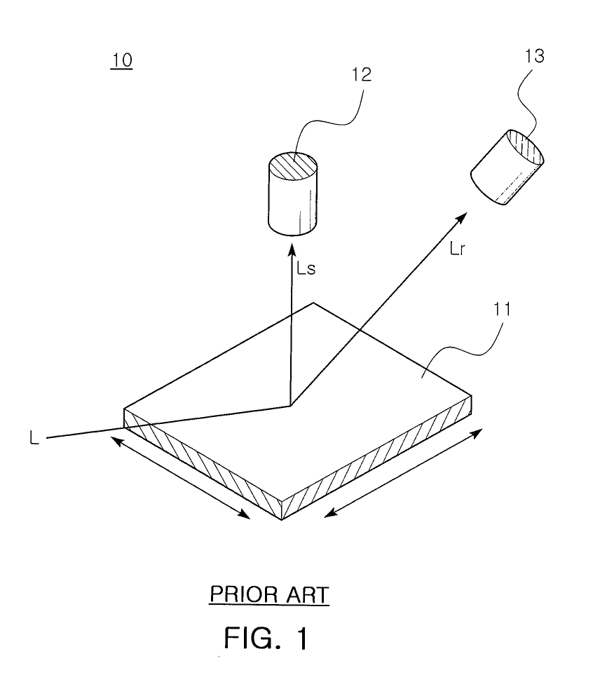

FIG. 2 is a flowchart illustrating a surface measurement method according to an exemplary embodiment of the present invention;

FIG. 3 is a perspective view illustrating a surface measurement apparatus according to another exemplary embodiment of the present invention;

FIG. 4 is a perspective view illustrating the surface measurement apparatus of FIG. 3;

FIGS. 5A and 5B are views illustrating changes in detection performance according to the shape of foreign bodies present on the surface of a target object;

FIG. 6 is a view illustrating a view illustrating a surface measurement apparatus according to another exemplary embodiment of the present invention; and

FIG. 7 is a view illustrating a view illustrating a surface measurement apparatus according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

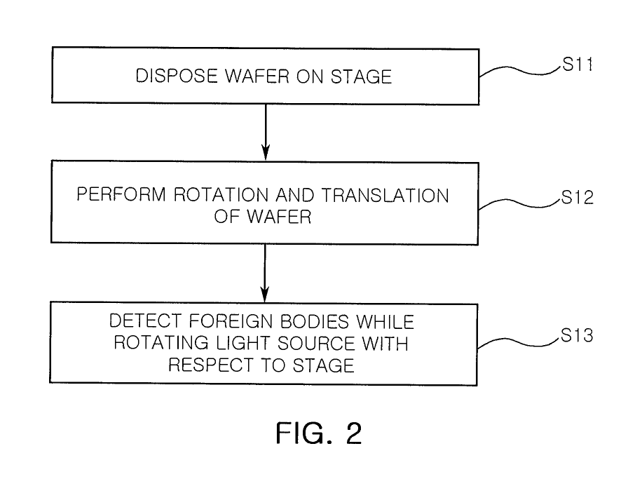

FIG. 2 is a flowchart illustrating a surface measurement method according to an exemplary embodiment of the invention. The surface measurement method according to this embodiment consists of three operations. In operation S11, a wafer is situated on a wafer. The wafer is a target object. In addition to the wafer, a PCB may also be used. Then, in operation S12, the rotation and translation of the wafer are performed. Two-dimensional scanning effects can be obtained from a fixed light source by realizing the rotation and translation of the wafer at the same time. To this end, a motor that is connected to the wafer may be disposed on the stage, and the stage may be situated on a transfer device that can perform a linear movement. Then, in operation S13, while beams are irradiated onto the wafer that is performing rotation and translation. Here, the wafer surface is measured while the light source performs a rotational movement relative to the stage. Since surface measurement requires various optical axes according to the shapes of foreign bodies, beams are irradiated onto the wafer surface while the light source is rotating with respect to the stage. This will be described below in more detail.

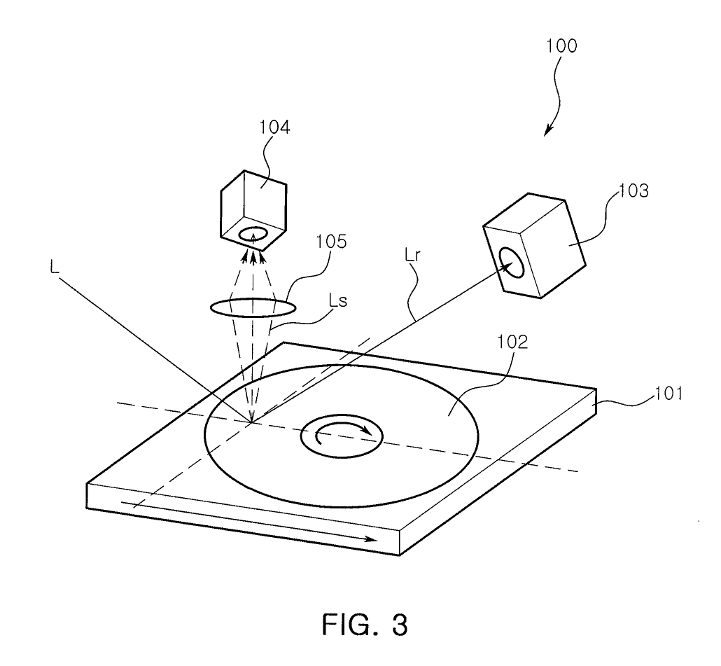

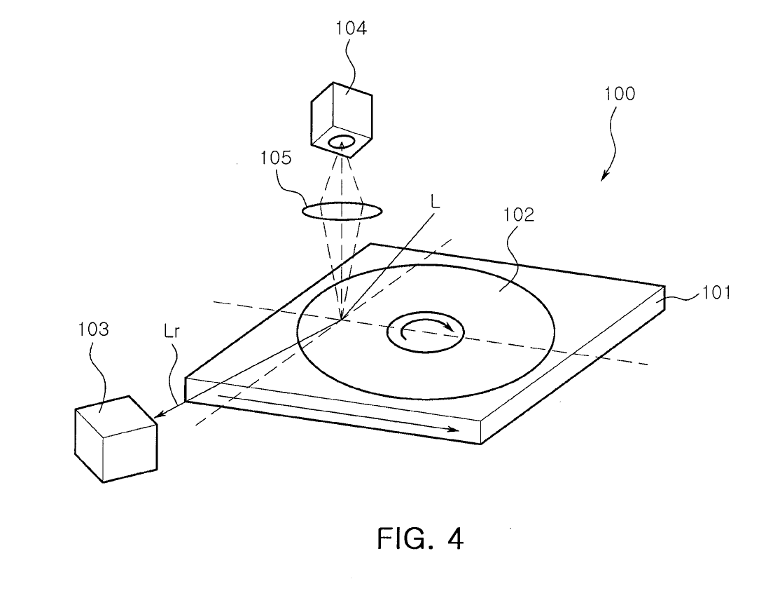

Hereinafter, a configuration of a surface measurement apparatus to which the surface measurement method, described in FIG. 2, is applied, will be described. FIGS. 3 and 4 are perspective views illustrating a surface measurement apparatus according to an exemplary embodiment of the invention. First, referring to FIG. 3, a surface measurement apparatus 100 according to this embodiment includes a light source L irradiating beams, a stage 101 receiving a target object 102 thereupon, a reflected-beam detection unit 103 and a scattered-beam detection unit 104. The light source L emits beams, which can be reflected and scattered from the target object 102, in order to measure the surface state of the target object 102. For example, the light source L emits laser beams and is movable relative to the stage 101.

The stage 101 receives the target object 102 on an upper surface thereof and causes a linear one-way movement and a rotational movement of the target object 102. As the target object 102 performs linear and rotational movements, the entire two-dimensional surface can be scanned using beams. Beams, emitted from the light source L, are reflected and scattered from the target object 102. Reflected beams Lr are received in the reflected-beam detection unit 103, and scattered beams Ls are received in the scattered-beam detection unit 104 through the focusing lens 105.

Each of the reflected-beam detection unit 103 and the scattered-beam detection unit 104 converts an optical signal into an electric signal and analyzes the electric signal. The scattered-beam detection unit 104 is disposed above the target object 102 and can determine the position of the target object 102 by converting an optical signal into an electric signal and analyzing the electric signal. Further, the scatter-beam detection unit 104 may correct the output of the reflected-beam detection unit 103. That is, the scattered-beam detection unit 104 detects the scattered beams from the target object 102, that is, a noise signal (associated with the scattered beams Ls) generated by diffuse reflection caused by foreign bodies present on the surface. If there is no foreign body or scratch on the surface of the target object 102 when beams are being scanned, most of the beams are not scattered but reflected, and the reflected beams are received in the reflected-beam detection unit 103. On the other hand, when foreign bodies are present on the surface of the target object 102, the intensity of the scattered beams Ls increases instantaneously. The position or the size of the foreign bodies can be detected by analyzing both the noise signal Ls and the reflected beams.

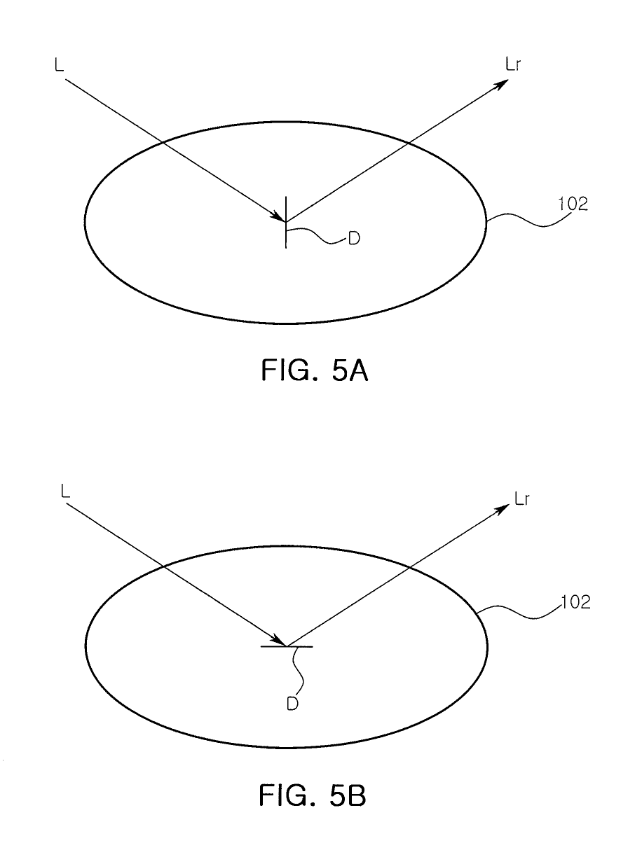

As described above, the light source L allows for a rotational movement around the stage 101. That is, as shown in FIG. 4, after the surface measurement with respect to the target object 102 is terminated in terms of a movement of the light source L along one direction, the position of the light source L is changed to alter an optical axis. In FIG. 4, the light source L is rotated at an angle of 90 degrees from the initial position of the light source L, shown in FIG. 3. The movement of the light source L involves the movements of the reflected-beam detection unit 103 and the scattered-beam detection unit 104. As the surface measurement is performed by rotating the light source L, detection performance may be improved by increasing the number of optical axes. Specifically, FIGS. 5A and 5B are views illustrating changes in detection performance varying according to the shapes of foreign bodies on the surface of the target object.

First, in FIG. 5A, a foreign body D on the surface of the target object 102 is perpendicular to an optical axis of these beams. In FIG. 5B, the foreign body D of the target object 102 is horizontal to the optical axis of the beams. Beams are more likely to be scattered at the surface when the foreign body D is perpendicular to the beams than when the foreign body D is horizontal to the beams. Therefore, detection performance can be improved by increasing the number of optical axes in comparison to a single optical axis. In this embodiment, the light source L can perform a rotational movement relative to the stage 101 at an angle between 0 degrees and 90 degrees. For example, the surface of the target object 102 is first measured at an angle of 0 degrees, and then is measured in order of 30 degrees, 60 degrees and 90 degrees. This measuring method may be appropriately changed in consideration of measurement speed and measurement performance. The surface of the target object 102 may be measured in order of 0 degrees, 45 degrees and 90 degrees. However, since the rotational movement of the light source L is relative to the stage 101, the light source L may be fixed and the stage 101 may perform a rotational movement around the light source L.

As described above, in this embodiment, the light source L rotates along with the rotation of the target object 102, and the rotation of the light source L and the rotation of the target object 102 perform different functions from each other. That is, the rotation of the target object 102 is coupled with the linear movement for two-dimensional scanning. Unlike this, the rotation of the light source L is performed to forcefully change the optical axis of the beams used for the surface measurement. When the target object 102 is only rotated without rotating the light source L, one foreign body is detected by beams being incident along one direction, and thus, detection performance is lower than detection performance when various optical axes are used. Therefore, even when the light source L rotates, beams, emitted from the light source L, may be irradiated onto a predetermined region within the stage, thereby obtaining the effects of using various optical axes.

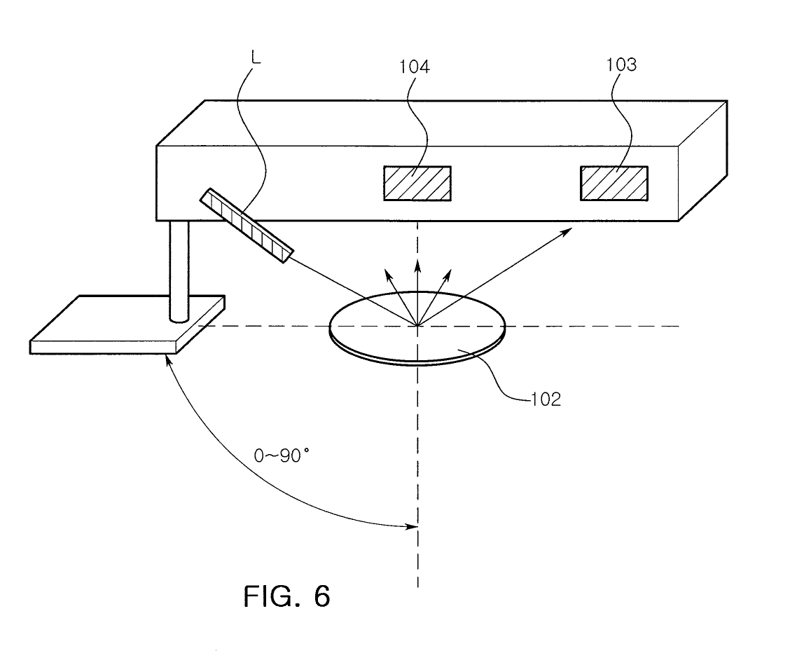

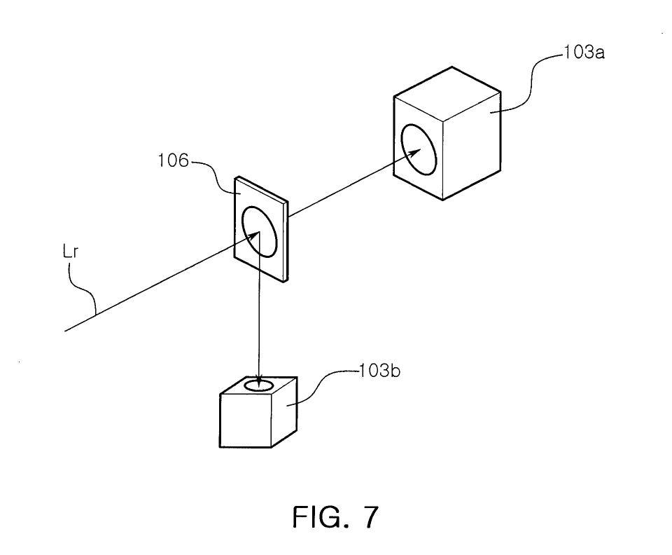

FIGS. 6 and 7 are views illustrating surface measurement apparatuses according to other exemplary embodiments of the invention.

As described above, as shown in FIG. 6, the light source L 104, the reflected-beam detection unit 103 and the scattered-beam detection unit 104 may be formed into a single body in that the movement of the light source L involves the movements of the reflected-beam detection unit 103 and scattered-beam detection unit

Further, the beams Lr, reflected from the target object 102, are split into two beams using a beam splitter 106, and the two split beams are respectively received in a reflected-light amount measurement unit 103a and a position signal detection unit (PSD) 103b, so that a three-dimensional shape can be measured. That is, the position signal detection unit 103b can detect changes in the angles of the reflected beams, and can measure a three-dimensional shape using triangulation based on the detection values. In this manner, the three-dimensional shape according to changes in morphology can be measured. Here, the reflected-light amount measurement unit 103a is the same as the reflected-beam detection unit, shown in FIG. 2. The beam splitter 106 can appropriately control beam transmittance (for example, 50%) by adjusting surface coating. In this embodiment, the one beam splitter 106 and the reflected-light amount measurement unit 103a and the position signal detection unit 103b are arranged. Alternatively, a plurality of beam splitters may be arranged according to detection requirements to thereby split beams into a greater number of beams.

As set forth above, according to exemplary embodiments of the invention, a surface measurement apparatus and a surface measurement method can maximize detection performance by detecting foreign bodies present on a surface regardless of optical axes of the beams used for detection.

While the present invention has been shown and described in connection with the exemplary embodiments, it will be apparent to those skilled in the art that modifications and variations can be made without departing from the spirit and scope of the invention as defined by the appended claims.

What is claimed is:

1. A surface measurement apparatus comprising:
a stage receiving a target object and causing linear and rotational movements of the target object;
a light source irradiating a beam onto the target object and performing rotating relative to the stage; and
a reflected-beam detection unit detecting a beam reflected from the target object.

2. The surface measurement apparatus of claim 1, wherein the light source performs a rotational movement relative to the stage at an angle between 0 degrees to 90 degrees.

3. The surface measurement apparatus of claim 1, wherein the light source performs a rotational movement around the stage that is fixed.

4. The surface measurement apparatus of claim 1, wherein the light source irradiates a beam onto a predetermined region while the light source is rotating.

5. The surface measurement apparatus of claim 1, wherein the light source and the reflected-beam detection unit are formed into a single body.

6. The surface measurement apparatus of claim 1, wherein the stage causes a linear one-way movement and a rotational movement of the target object at the same time during measurement.

7. The surface measurement apparatus of claim 1, wherein the reflected-beam detection unit comprises first and second reflected-beam detection units, and further comprises a beam splitter splitting a beam moving toward the reflected-beam detection unit and supplying the split beams to the first and second reflected-beam detection units.

8. The surface measurement apparatus of claim 7, wherein the first reflected-beam detection unit is a position signal detection unit, and the second reflected-beam detection unit is a reflected-light amount measurement unit.

9. The surface measurement apparatus of claim 1, further comprising a scattered-beam detection unit located above the target object and detecting a beam scattered from the target object.

10. The surface measurement apparatus of claim 9, further comprising a focusing lens focusing the beam scattered from the target object and supplying the focused beam to the scattered-beam detection unit.

11. A surface measurement method comprising:
disposing a target object on a stage;
performing linear and rotational movements of the target object;
emitting a beam from a light source and irradiating the beam onto the target object; and
disposing a reflected-beam detection unit and detecting beams reflected from the target object,
wherein the irradiating of the beams onto the target object is performed while the position of the light source is shifted relative to the stage.

12. The surface measurement method of claim 11, wherein the irradiating of the beams onto the target object is performed while the light source performs a rotational movement relative to the stage.

13. The surface measurement method of claim 12, wherein the rotational movement is performed at an angle between 0 and 90 degrees.

14. The surface measurement method of claim 12, wherein the irradiating of the beams onto the target object is performed at positions of 0 degrees, 45 degrees and 90 degrees, when the original position of the light source is at an angle of 0 degrees with respect to the stage.

15. The surface measurement method of claim 12, wherein the irradiating of the beams onto the target object is performed at positions of 0 degrees, 30 degrees, 60 degrees and 90 degrees, when the original position of the light source is at an angle of 0 degrees with respect to the stage.

16. The surface measurement method of claim 11, wherein the light source and the reflected-beam detection unit are formed into a single body.
